(19) United States
(12) Patent Application Publication
(10) Pub. No.: US 2018/0267193 A1
(43) Pub. Date: Sep. 20, 2018

(54) ELECTROMAGNETIC SURVEY SYSTEM BUCKING SYSTEM ENHANCEMENT

(71) Applicant: GEOTECH LTD., Aurora (CA)

(72) Inventor: Jack DODDS, Aurora (CA)

(73) Assignee: GEOTECH LTD., Aurora, ON (CA)

(21) Appl. No.: 15/537,341

(22) PCT Filed: Dec. 16, 2015
(86) PCT No.: PCT/CA2015/051334

§ 371 Date: Jun. 16, 2017

(51) Int. Cl. G01V 3/10; G01V 3/165; G01V 3/38; G01V 3/36; G01V 3/40

(52) U.S. Cl. CPC G01V 3/107; G01V 3/165; G01V 3/40; G01V 3/36; G01V 3/38

(57) ABSTRACT

A bucking system for an electromagnetic survey system which uses a network to interconnect the turns of a transmitter coil with the turns of one or more bucking coils in which the network includes passive circuit elements which to provide accurate bucking of the transmitter coil field at a sensor location, both when the current through the loop is steady and when the current is changing rapidly.

This application claims the benefit of and priority to U.S. Patent Application No. 62/092,564, filed Dec. 16, 2014, the contents of which are incorporated herein by reference.

### BACKGROUND

Embodiments described herein relate to the field of geological mapping.

Active source electromagnetic (EM) surveying encompasses ground based and airborne applications. In EM geological mapping, a magnetic receiver is used to measure the magnetic response of the earth (“earth response”) to a primary magnetic field (“primary field”) transmitted by the survey system. The relation between the transmitted primary field and the earth response is used to calculate the electrical resistivity structure of the earth, from which geological information is inferred.

EM surveying includes both frequency domain EM (FDEM) and time domain EM (TDEM) techniques. In FDEM, the earth response is measured as a function of frequency. In TDEM, the earth response is measured as a function of time after a transmitted pulse.

In all FDEM and TDEM techniques, the magnetic receiver senses the superimposed primary field and earth response. In order to determine the earth response, the component caused by the primary field must be removed from the received signal.

EM surveying is implemented using ground, water, and airborne equipment. Airborne systems exist for both fixed wing and helicopter aircraft.

In the case of helicopter borne EM systems, the receiver and transmitter may be attached to a structure (“bird”) which is towed by the helicopter. In some systems the receiver is located close to the receiver and the primary field magnitude is large relative to the earth response.

In a practical EM survey system, a time varying electric current (“transmitter current”) is passed through a wire coil or loop (“transmitter loop”), thereby generating a time varying magnetic field (“primary field”). The magnetic field induces electric currents in the earth, which generate a secondary magnetic field. The earth response is sensed by one or more receivers and is recorded by a data acquisition system. The receiver may itself be a wire coil or loop (“receiver coil”), although other types of receivers have been used.

In some EM systems, the effect of the primary magnetic field on the receiver may be reduced by the use of an additional coil or loop (“bucking loop”). The function of the bucking loop is to cancel the effect of the primary field on the receiver.

When a bucking loop is present, the transmitter current may be sensed by a current sensor and recorded by the data acquisition system, in addition to the receiver signals, since it cannot be measured accurately by the receiver.

In some EM systems, the bucking coil is designed so as to provide accurate and stable cancellation of the effect of primary field, so that the receiver sees a signal which depends substantially on the earth response only.

In some EM systems, the bucking coil is used to reduce the dynamic range of the received signal, to allow use of a more sensitive receiver having lower noise than would be possible in the absence of the bucking coil, but the cancellation is not relied upon to accurately cancel the primary field.

In some EM systems, the bucking coil is part of the circuit through which the transmitter current flows. For example, it may be in series with the main transmitter loop. In that case the bucking coil is configured and positioned so that it substantially cancels the magnetic field of the main transmitter loop within a defined spatial region close to the main transmitter loop, without substantially affecting the field at positions distant from the main transmitter loop. This may be accomplished by making the bucking loop smaller in diameter than the main loop, with fewer turns, to produce a region of cancellation at the center of the bucking loop. The receiver is then positioned in the region of cancellation. This configuration may be used when the receiver is a coil or loop, or when another type of receiver is used.

In some EM systems in which the receiver is a coil or loop, the bucking coil is part of the receiver circuit. For example, the bucking loop may be in series with the receiver coil. In that case the bucking coil is configured and positioned so that it substantially cancels the electric signal produced by the main transmitter loop in the receiver coil, without substantially affecting the response of the receiver coil to the secondary magnetic fields generated by the earth. This may be accomplished by placing the bucking coil closer to the main transmitter loop than the receiver coil, while providing the bucking coil with fewer or smaller turns than the receiver coil.

Examples of EM systems which include bucking coils may be found in patent applications PCT WO2010/022515A1, US 2003/0169045A1, US 2014/0285206 among others.

### SUMMARY

According to an example embodiment there is provided an EM system for geophysical surveying. The EM system includes a transmitter controller for generating a transmitter current with a controlled waveform; a current sensor for which measures the transmitter current waveform; a transmitter loop for generating a primary magnetic field; a bucking loop for generating a magnetic field that substantially cancels the primary field in a defined region; a network connected at two or more points to the transmitter loop and bucking loop; a magnetic receiver (which may comprise multiple sensors with different, possibly orthogonal, sensitive directions) positioned in the region of cancellation; a data acquisition system which records the signals from the current sensor and the receiver; a structure (bird) which supports the transmitter loop, network, bucking loop, and receiver; and an aircraft which tows the bird and carries the transmitter and data acquisition system.

According to an example embodiment there is provided a method for optimizing the accuracy of the bucking function, wherein the system is operated at high altitude to minimize the earth response; the acquired data is analyzed to determine parameters of the residual primary field waveform in the cancellation region; the network is adjusted according to predefined rules to reduce the residual primary field; and the process is repeated until a predefined level of residual field is achieved, or no further reduction can be obtained.

### BRIEF DESCRIPTION OF THE DRAWINGS

FIG. 1 is a diagram of an example of an airborne time domain electromagnetic system to which example embodiments of the systems and methods described herein can be applied.

FIG. 2 is a diagram showing a configuration of transmitter coil, bucking coil, and receiver that can be applied to the airborne time domain electromagnetic system of FIG. 1 according to example embodiments.

FIG. 3 is a diagram showing an interconnect network that can be connected to the bucking loop and transmitter loop of the configurations of FIG. 2 to allow optimization of the bucking performance, according to example embodiments.

FIG. 4 is a diagram showing further example of a configuration of transmitter coil, bucking coil, and receiver that can be applied to the airborne time domain electromagnetic system of FIG. 1 according to example embodiments.

FIG. 5 is a diagram showing a further example of a configuration of transmitter coil, bucking coil, and receiver that can be applied to the airborne time domain electromagnetic system of FIG. 1 according to example embodiments in which the bucking loop and receiver are located off center, close to the turns of the transmitter loop, and the diameter of the bucking loop is much smaller than the diameter of the transmitter loop.

FIG. 6 is a diagram showing an alternative embodiment of an interconnect network for the transmitter coil and bucking coil according to example embodiments.

### DESCRIPTION OF EXAMPLE EMBODIMENTS

In any configuration using a bucking coil, it is possible to optimize the cancellation of the primary field, for example by moving the receiver and bucking coil to positions of greater or lesser primary field amplitude. A limitation of this process is that the behavior of the transmitter, receiver, and bucking coils is a function of frequency or delay time. A position that is optimum for one frequency or delay time may produce poor cancellation at a different frequency or delay time. Specifically, parasitic (“stray”) capacitance between turns of the transmitter, receiver, and bucking loops and coils will result in slightly different current waveforms flowing in each of the turns of each of these components of the system, and the relative differences increase with frequency due to the lower reactance of the parasitic capacitance and the higher reactance of the loop and coil inductance. This causes the accuracy of the bucking to diminish with increasing frequency. In the time domain, this is seen as reduced accuracy at times when the transmitter current is changing rapidly, which especially affects early delay times.

Example embodiments of a bucking enhancement for an EM survey system for geological mapping will now be described.

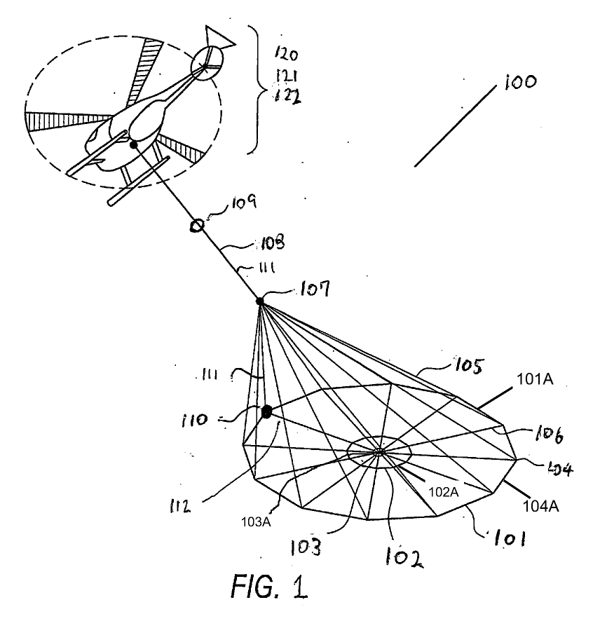

For the purposes of explaining the example embodiments, FIG. 1 shows a schematic view of an active source airborne TDEM survey system that incorporates a bucking enhancement. The TDEM survey system 100 includes a transmitter loop assembly 101, a bucking loop assembly 102, and a sensor assembly 103. The transmitter loop assembly 101, which houses an internal transmitter coil 101A in the form of a wire having one or more turns, is polygonal and consists of multiple rigid tubular straight sections 104A joined at vertices 104, which are designed to allow limited motion of sections 104A relative to each other so as to reduce stresses on the sections 104A of the transmitter loop assembly during takeoff and landing. The vertices 104 of the transmitter loop assembly 101 are supported and held in position relative to each other by suspension ropes 105 and radial ropes 106.

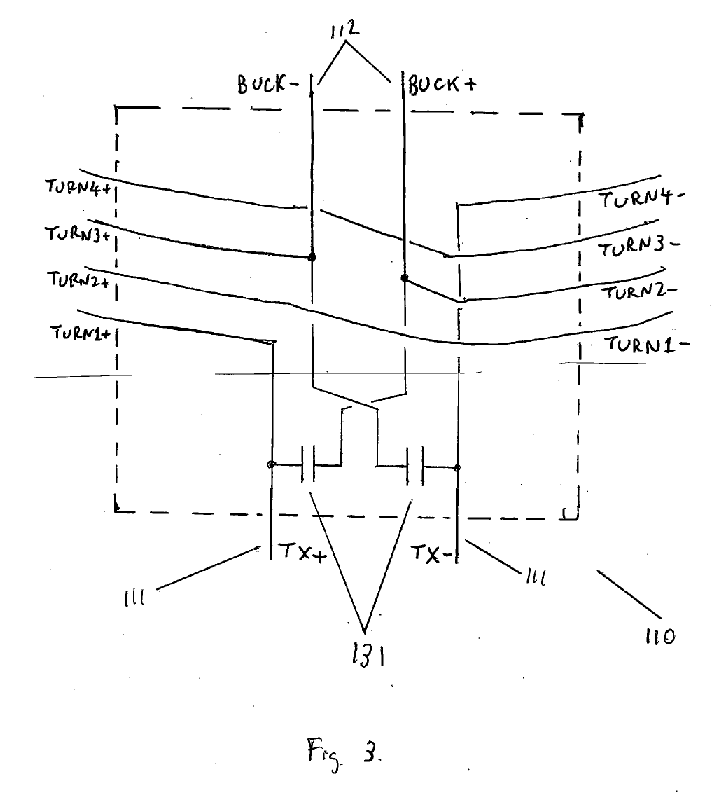

The bucking loop assembly 102, which houses a bucking coil 102A of one or more turns, is also polygonal, consisting of multiple tubular straight sections joined at vertices which allow limited relative motion. The bucking loop assembly vertices may also be supported by and held in position relative to the transmitter loop assembly and each other by the radial ropes 106 and by additional suspension ropes, which have been omitted for clarity in the drawing. The sensor assembly 103, which houses a sensor 103A such as a receiver coil, is held in position by the radial ropes and by additional suspension ropes 105, which have been omitted for clarity in the drawing. The suspension ropes 105 meet at a tow point 107. Electrical wires 111 that drive the transmitter coil 101A of the transmitter loop assembly 101 are connected to a transmitter driver 121 carried within an aircraft such as helicopter 120, run down the tow cable 108, passing through a current sensor 109, to the tow point 107, and then down a suspension rope to the network 110. The transmitter coil 101A, wires 111, and bucking coil leads 112 (FIG. 3) are interconnected at an interconnect network 110. Signals from the sensor 103A are transmitted via electrical wires which run up a suspension rope to the tow point 107, up the tow cable 108, to a data recording system 122 that is carried by the helicopter 120.

The semi-flexible tow assembly configuration shown in FIG. 1 is merely one example of many possible physical configurations of the TDEM survey system 100. In some example embodiments the transmitter coil, bucking coil, and receiver sensor are be supported by a rigid body or frame which does not deform during takeoff and landing. In some example embodiments the transmitter coil and the bucking coil are circular or some irregular shape. In some example embodiments transmitter coil, bucking coil and receiver sensor are positioned so that they are not concentric. The transmitter could be supported on the tow rope, or on the transmitter loop assembly. In some example embodiments, multiple bucking coils are present. Examples of embodiments including multiple bucking coils can be found in U.S. patent application 2014/0285206.

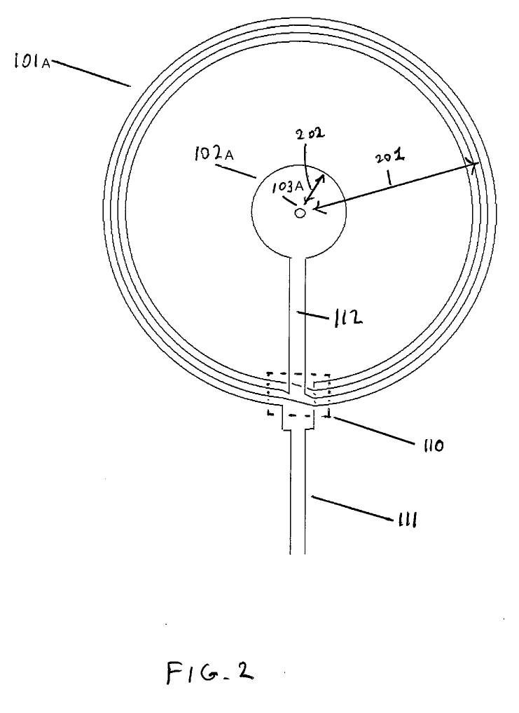

FIG. 2 is a diagram showing a configuration of transmitter coil 101A, bucking coil 102A, and receiver 103A in which the receiver 103A is located substantially at the center of the transmitter coil 101A and bucking coil 102A. In the example embodiment of FIG. 2, the transmitter coil 101A of the transmitter loop assembly 101 and the bucking coil 102A of the bucking loop assembly 102 are shown schematically and without their supporting mechanical structure as substantially circular, although as in FIG. 1 they may be polygonal. The transmitter coil 101A is formed from four wires creating a four turn loop. The bucking coil 102A is a one wire loop and is concentric and coplanar with the transmitter coil 101A. The receiver sensor 103A is located at the common center of both coils 101A, 102A. The radius 201 of the transmitter coil 101A is 4 (four) times the radius 202 of the bucking coil 102A. The network 110 interconnects the turns of the main transmitter coil 101A and the bucking coil leads 112 so that they are placed in series and connected to the wires 111 bringing current from the transmitter driver 121. Consequently, if the transmitter coil 101A outputs a steady current, all turns of the transmitter coil and bucking coil will carry the same current, but the direction of the current around the bucking coil will be opposite to the direction of the current through the transmitter coil. Given that the ratio of transmitter coil radius to bucking coil radius is equal to the ratio of transmitter coil turns to bucking coil turns (=4, in this embodiment), known physical principles can be used to show that, at the common center, the magnetic field of the bucking coil is equal and opposite to field of the main transmitter coil. (See for example, J. Simpson, J. Lane, C. Immer and R. Youngquist. 2001. Simple analytic expressions for the magnetic field of a circular current loop. NASA/TM-2013-217919) The transmitter coil field will be substantially bucked out at and near the common center point, which is the location of the receiver sensor 103A. This configuration of transmitter coil and bucking coil has been used, for example, in the invention described in U.S. Pat. No. 8,400,157.

In the embodiment of FIG. 2, it is desirable as a practical matter to position the four turns of the main transmitter coil 101A in close proximity to one another (e.g. <0.1 m separation) so as to minimize the size of the supporting mechanical structure due to aerodynamic considerations. Consequently, there is significant parasitic capacitance between the individual turns of the transmitter coil 101A. When the current output by the transmitter coil 101A is rapidly changing, there will similarly be rapidly changing voltage differences between the turns resulting in significant displacement currents through the parasitic capacitance. Under these conditions the current in the turns of the transmitter coil 101A and the bucking coil 102A will not be the same, so that there will be a residual “unbucked” magnetic field at the receiver location.

Referring to FIG. 3, the bucking performance of the configuration of FIG. 2 can be improved by adding components, including for example passive circuit elements, to the network 110 to make the bucking coil current more closely match the average transmitter coil current. The modified interconnect network 110 of FIG. 3 consists of one capacitor 131 shunting the first two turns of the transmitter loop, and a second capacitor 131 shunting the last two turns of the transmitter loop. In one example embodiment, two identical capacitors 131 are connected between the transmitter coil wires and the bucking coil 102A, so that one capacitor 131 is in parallel with transmitter coil turns 1 and 2 and the other capacitor 131 is in parallel with transmitter coil turns 3 and 4. The capacitor value which provides the best bucking performance depends on the dimensions of the coils 101A, 102A, the separation between the wires in the coil 101A and other factors including the insulation of the wires and the dielectric constant of the wires.

In one example embodiment, in order to determine the best capacitor value, the system 100 is flown at high altitude (to eliminate the effect of the earth on the response), the transmitter coil 101A is used to generate a pulsed output at its normal operating frequency, and the response of the receiver sensor 103A is recorded. This test is performed with various values of capacitance, adjusting the capacitance before each test based on the results of the prior tests, until the response of the receiver sensor 103A at the turn-off of the pulse has been minimized.

More specifically, given a new configuration of transmitter coil and bucking coil, the initial value of capacitors 131 to be tested may first be determined from tests on the transmitter coil on the ground. Using known methods (e.g. Tektronix Inc. Capacitance and inductance measurements using an oscilloscope and a function generator. Application Note) inductance L and self-resonant frequency f_{SRF} of the transmitter coil is measured at its connection to the transmitter. (e.g. Tektronix Inc. Capacitance and inductance measurements using an oscilloscope and a function generator. Application Note). The equivalent parallel capacitance C_{P}=1/(2πf_{SRF})²/L is calculated. At high altitude, the response at the receiver sensor 103A to the transmitter coil 101A turnoff is measured with no capacitors 131, then with capacitance 0.1 C_{P}, doubling the capacitance value in successive tests until a significant reduction of the response is observed. Then the capacitance value is adjusted for minimum response.

Alternatively, the best capacitor value can be determined by simulating the behavior of the transmitter coil, bucking coil, and receiver using know circuit simulation software (e.g. University of California at Berkeley, Spice circuit simulator, http://bwrcs.eecs.berkeley.edu/Classes/IcBook/SPICE/MANUALS/spice3.html). The self and mutual inductances and parasitic capacitances between each turn or half-turn in the transmitter coil 101A, bucking coil 102A, and a sensor 103A, are calculated from known theory. The simulation software is then used to calculate the response of the sensor 103A to sinusoidal currents input to the transmitter coil terminals. The network capacitance values are then adjusted to minimize the response at a frequency comparable to the self-resonant frequency of the transmitter coil. Due to uncertainties in the theoretical calculations of the circuit parameters, it is prudent to verify the simulation results experimentally as described above.

In one example embodiment, the transmitter coil 101A is 13 m in radius and has four turns. The separation between the turns of the coil 101A is 15 mm-55 mm depending on the construction. Capacitor values that give the best results are in the range 0.6 nF-3 nF

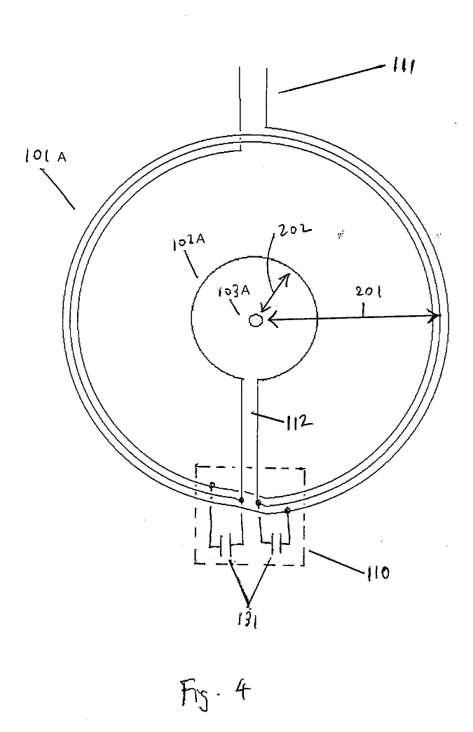

Referring to FIG. 4, in a further example embodiment of a system that employs modified interconnect network 110 is shown schematically; the transmitter coil 101A has three turns and the radius 201 of the transmitter coil 101A is three times the radius 202 of the bucking coil 102A. Wires 111 bringing current from the transmitter driver 121 are connected to at a position on the opposite side of the coil from the network 110, and the capacitors 113 each shunt one turn of the transmitter coil.

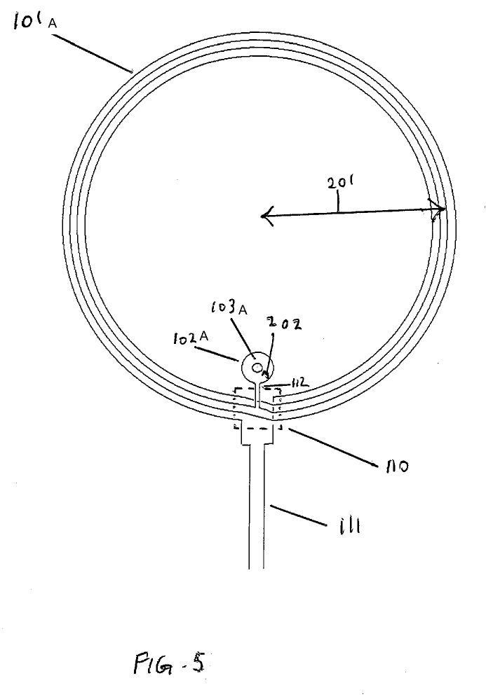

Referring now to FIG. 5, in a further example embodiment shown schematically the transmitter coil 101A has four wires providing four turns, the radius of the bucking coil 102A is smaller than in the embodiment of FIG. 2, and the receiver sensor 103A and bucking coil 102A are concentric with each other, but close to the periphery of the transmitter coil 101A. Relative to the embodiment of FIG. 2, the transmitter coil 101A field is stronger at the receiver sensor location near the periphery, while the bucking coil field at the receiver sensor is stronger due to the reduced bucking coil radius. Using known physical principles, the position of the bucking coil 102A and receiver sensor 103A is chosen to match the bucking coil field to the main coil field to achieve accurate bucking. The parasitic capacitance between the turns of the transmitter coil will affect the bucking just as in the embodiment of FIG. 2, and the network of FIG. 3 is used, with the previously described method of adjustment, to improve the bucking performance.

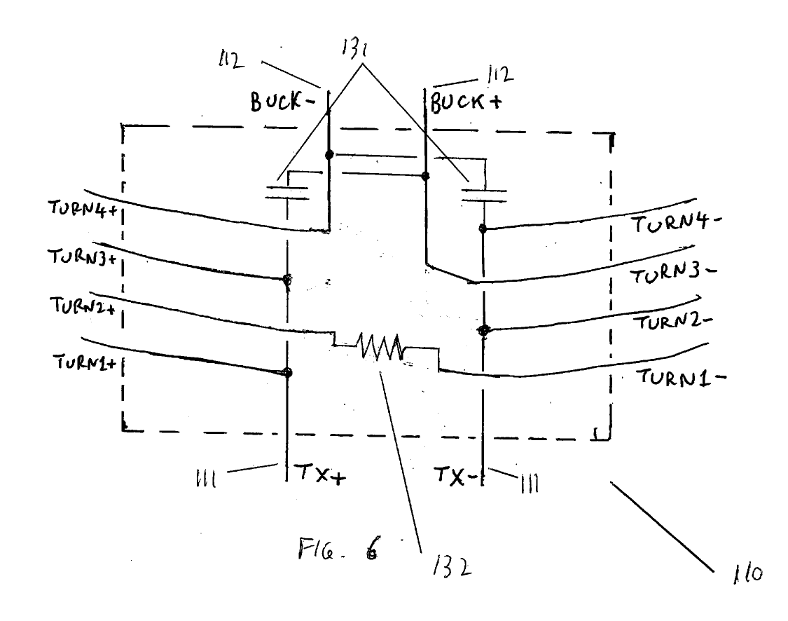

Referring now to FIG. 6, in a further example embodiment, the network 110 connects the turns of the transmitter coil 101A in series-parallel. In such a configuration, the transmitter current divides into two parallel branches, with one branch comprising two turns of the transmitter coil and the bucking coil in series, together with capacitors in parallel with each of the transmitter loop turns; while the other branch comprises two turns of the transmitter loop in series with an equalizing resistance. In the illustrated example turns 3, 4 of the transmitter coil 101A and the bucking coil 102A (via the leads 112) are connected in series; Turns 1, 2 of the transmitter coil 101A and an equalizing resistor 132 are connected in series; the two series combinations are connected in parallel to the transmitter driver output wires 111. The resistance 132 is selected to match the resistance of the bucking coil (including the wires 112 which connect to it) so that the current from the transmitter is divided equally between the two series branches of the circuit. The series-parallel topology may have an advantage when it is desired to reduce the turn-off time of the transmitter waveform, since it will result in a reduction of the inductance of the transmitter coil, according to known physical principles. The embodiment of FIG. 6 achieves this reduction without a change in the diameter of the bucking coil 102A. It may therefore be useful in an embodiment which is designed to be easily converted from the series configuration to the series-parallel configuration.

In some embodiments, the equalizing resistance 132 may be a length of wire which is positioned beside the leads 112 to the bucking coil, but doubled back on itself so as to create no significant magnetic field. In some embodiments it may be positioned beside the turns of the transmitter coil 101A, doubled back to as to create no significant magnetic field. These embodiments allow the heat generated in the equalizing resistance to be easily dissipated.

The particular embodiments disclosed above are illustrative only and should not be taken as limitations upon the present invention, as the invention may be modified and practiced in different but equivalent manners apparent to those skilled in the art having the benefit of the teachings herein. Accordingly, the foregoing description is not intended to limit the invention to the particular form set forth, but on the contrary, is intended to cover such alternatives, modifications and equivalents as may be included within scope of the description so that those skilled in the art should understand that they can make various changes, substitutions and alterations without departing from the scope of the appended claims. In addition, features from one or more of the above-described embodiments may be selected and combined to create alternative embodiments comprised of a combination of features which may not be explicitly described above. Features suitable for such combinations and sub-combinations would be readily apparent to persons skilled in the art upon review of the present application as a whole. The subject matter described herein and in the recited claims intends to cover and embrace all suitable changes in technology.

1. An electromagnetic surveying system comprising:
a transmitter driver for generating a time varying waveform;
a multi-turn transmitter coil for generating a primary field in response to the time varying waveform;
a bucking coil for generating a cancelling field that reduces the primary field within a cancellation region;
a receiver sensor for sensing a magnetic field within the cancellation region;
a data acquisition system for acquiring signals from the receiver sensor; and
an interconnect network that interconnects the transmitter coil and the bucking coil, the interconnect network including circuit elements to reduce an effect of parasitic capacitance between turns of the transmitter coil on the cancelling field generated by the bucking coil.

2. The system of claim 1 wherein the circuit elements include passive elements configured to match current in the bucking coil to current in the transmitter coil.

3. The system of claim 1 wherein the interconnect network connects the bucking coil in series with the transmitter coil and the circuit elements include one or more capacitor devices shunting at least some of the turns of the transmitter coil.

4. The system of claim 3 wherein an equal length of the transmitter coil is connected in series to each end of the bucking coil.

5. The system of claim 4 wherein the capacitor devices include a first capacitor device connected between one end of the bucking coil and a first output of the transmitter driver and a second capacitor device connected between an opposite end of the bucking coil and a second output of the transmitter driver, the first and second capacitor devices having the same capacitance.

6. The system of claim 1 wherein multiple turns of the transmitter coil are connected in series with a resistive device to provide a first current path and multiple turns of the transmitter coil are connected in series with the bucking coil to provide a second current path, and the first current path and second current path are connected in parallel, the resistive device being selected to match a resistance of the bucking coil such that current from the transmitter driver is divided substantially equally between the first and second current paths, wherein the circuit elements include one or more capacitor devices shunting at least some of the turns of the transmitter coil.

7. The system of claim 1 comprising a support assembly that supports the bucking coil substantially concentric with the transmitter coil and the receiver sensor at the cancellation region, the cancellation region being at a common center of the bucking and transmitter coils.

8. The system of claim 1 comprising a support assembly that supports the bucking coil substantially and the transmitter coil with the bucking coil being located off-center of the transmitter and the receiver sensor at the cancellation region, the cancellation region being at a center of the bucking coil.

9. The system of claim 7 wherein the support assembly is suspended from a helicopter.

10. A method for airborne electromagnetic surveying using magnetic sensor comprising:
applying a time varying current waveform to a multi-turn transmitter coil to generate a primary field towards earth;
using a bucking coil to provide a cancelling effect on the primary field at a location of the magnetic sensor; and
sensing, using the magnetic sensor, a secondary response from the earth resulting from the primary field, wherein
the transmitter coil and bucking coil are interconnected using circuit elements that reduce effects of parasitic capacitance within the transmitter coil on the cancelling effect.

11. The method of claim 10 wherein the circuit elements include one or more passive capacitors that shunt at least some of turns of the transmitter coil.

12. The method of claim 11 wherein the transmitter coil is connected in series with the bucking coil.

13. The method system of claim 12 wherein the one or more passive capacitors include a first capacitor device connected between one end of the bucking coil and a first output of a transmitter driver that applies the time varying current waveform and a second capacitor device connected between an opposite end of the bucking coil and a second output of the transmitter driver, the first and second capacitor devices having the same capacitance.

14. The method of claim 11 multiple turns of the transmitter coil are connected in series with a resistive device to provide a first current path and multiple turns of the transmitter coil are connected in series with the bucking coil to provide a second current path, and the first current path and second current path are connected in parallel, the resistive device being selected to match a resistance of the bucking coil such that current from the transmitter driver is divided substantially equally between the first and second current paths.

15. The method of claim 10 comprising calibrating operation of the bucking coil by:
sensing, using the magnetic sensor, the cancelling effect when the transmitter coil, bucking coil and magnetic sensor are at a high altitude at which the secondary response from the earth resulting from the primary field is negligible; and
adjusting the circuit elements to maximize the cancelling effect at the high altitude.

16. A system for bucking out the primary field of a transmitter coil of an electromagnetic survey system at a sensor location comprising:
a bucking coil; and,
a network which interconnects turns of the transmitter coil with the bucking coil, the network including one or more passive circuit elements which are configured to provide accurate bucking of the transmitter coil field at the sensor location, both when a current through the transmitter coil is steady and when the current is changing rapidly.

17. The system of claim 16 in which the one or more passive circuit elements of the network include a capacitor or capacitors.

18. The system of claim 17 wherein the network connects the bucking coil and all the turns of the transmitter coil in series, and the capacitor or capacitors shunt some of the turns of the transmitter coil.

19. The system of claim 18 wherein an equal number of the turns of the transmitter coil is connected in series to each end of the bucking coil.

20. The system of claim 16 wherein the bucking coil is substantially concentric with the transmitter coil, and the sensor location is at a common center of the coils.
